(19) United States
(12) Patent Application Publication
(10) Pub. No.: US 2024/0339774 A1
(43) Pub. Date: Oct. 10, 2024

(54) BOARD END CONNECTOR AND PLUG

(71) Applicant: BIZLINK INTERNATIONAL CORP., New Taipei City (TW)

(72) Inventors: Yi-Hsing CHUNG, New Taipei City (TW); Shi-Jung CHEN, New Taipei City (TW)

(21) Appl. No.: 18/625,625

(22) Filed: Apr. 3, 2024

(30) Foreign Application Priority Data
Apr. 6, 2023 (TW) 112112973

(51) Int. Cl. H01R 12/72; H01R 13/46; H01R 13/627

(52) U.S. Cl. CPC H01R 12/722; H01R 13/46; H01R 13/6273

(57) ABSTRACT

A board end connector includes a cage. The cage surrounds a accommodating space. The cage has at least one elastic bridge and at least one alignment hole. The elastic bridge is located on a surface of the cage and recessed toward the accommodating space. When the elastic bridge is abutted against an external component, the elastic bridge is elastically deformed and applies a reverse force to the external component, thereby changing the position of a portion of the external component in the alignment hole.

### CROSS-REFERENCE TO RELATED APPLICATIONS

This application claims priority to Taiwan Application Serial Number 112112973, filed Apr. 6, 2023, which is herein incorporated by reference.

### BACKGROUND

### Field of Invention

The present disclosure relates to a connector structure, especially relates to a board end connector and a plug.

### Description of Related Art

As the transmission rate of high-speed connectors increases, the stability of each connector when coupled has an increasingly significant impact on signal transmission.

For example, after a traditional wire-end connector used in a server is connected with the board-end connector, vibrations or external forces may cause the wire-end connector to shift. Consequently, the electrical connection between the contacts of the wire-end connector and the board-end connector may be affected, thus impacting transmission quality.

### SUMMARY

In view of this, one purpose of the present disclosure is to provide a board-end connector with a cage and a plug to solve the aforementioned problems.

In summary, in one embodiment, by forming a bridge-like elastic structure on the cage, the structure may push the plug backward to ensure that the rear surface of the ramp abut against and contacts with the cage, thus avoiding or decreasing vibration.

In another embodiment, a plug with two latches formed on its two lateral surfaces may further secure the plug within the cage.

In another embodiment, the cage may have two openings, one allowing the plug with a cable to be inserted therein, providing a port inside the cage for another cable end connector to be connected therewith.

### BRIEF DESCRIPTION OF THE DRAWINGS

Aspects of the present disclosure are best understood from the following detailed description when read with the accompanying figures. It is noted that, in accordance with the standard practice in the industry, various features are drawn accurately according to the real scale. In order to simplify the disclosure, some details may not be shown. However, the proportion and relative relationship of each element should be regarded as a part of the content of the present disclosure and serve as the basis for subsequent limitations.

FIG. 1 is a perspective view of a board end connector coupled with a plug according to one embodiment of the present disclosure.

FIG. 2 is another perspective view of the board end connector coupled with the plug shown in FIG. 1.

FIG. 3 is a perspective view of a board end connector of the board end connector of FIG. 1.

FIG. 4 is a partially enlarged view of the board end connector of FIG. 3.

FIG. 5 is a perspective view of the plug of FIG. 1.

FIG. 6 is a partially enlarged view of the plug of FIG. 5 when being coupled with the board end connector of FIG. 4.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

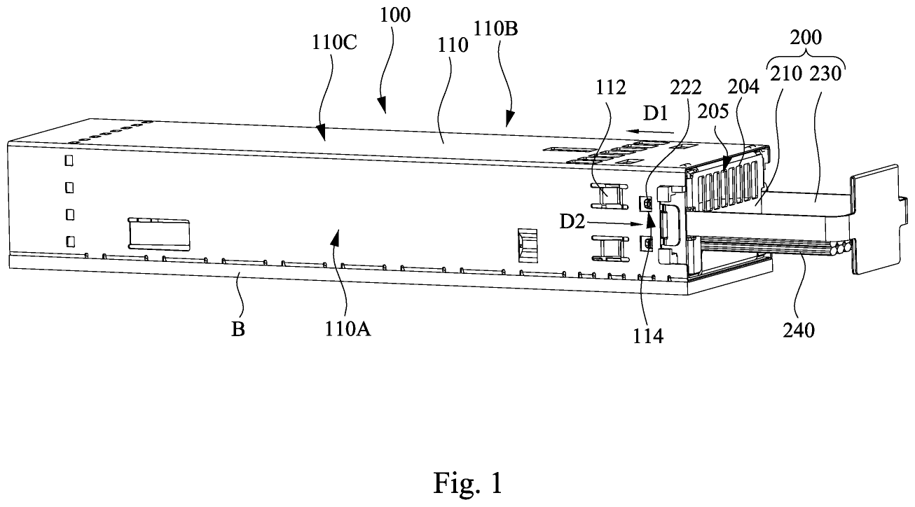

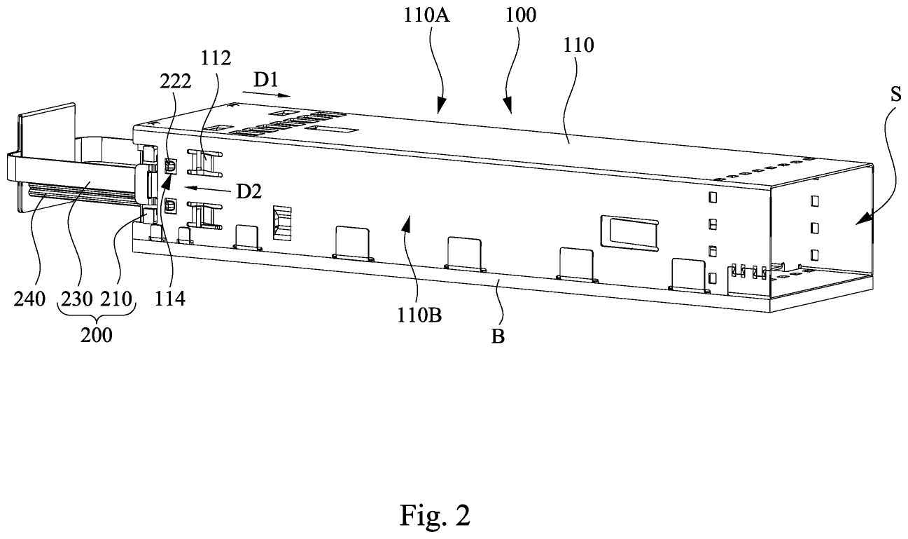

FIG. 1 is a perspective view of a board end connector, the connector having a cage 100 coupled with a plug 200 according to one embodiment of the present disclosure. FIG. 2 is another perspective view of the cage 100 coupled with the plug 200 shown in FIG. 1.

The cage 100 and the plug 200 may comply with high-speed connectors such as OSFP, etc.

As shown in FIG. 1 and FIG. 2, the cage 100 is rod shaped. In this embodiment, the entirety of the cage 100 is formed by bending a metal sheet through a stamping process. The cage 100 having a top wall 100C, a bottom wall 100D, a first lateral wall 100A and a second lateral wall 100B, the first lateral wall 100A and a second lateral wall 100B connecting the top wall 100C and the bottom wall 100D respectively for forming an accommodating space S therein, and the accommodating space S may allow the plug 200 to be inserted therein.

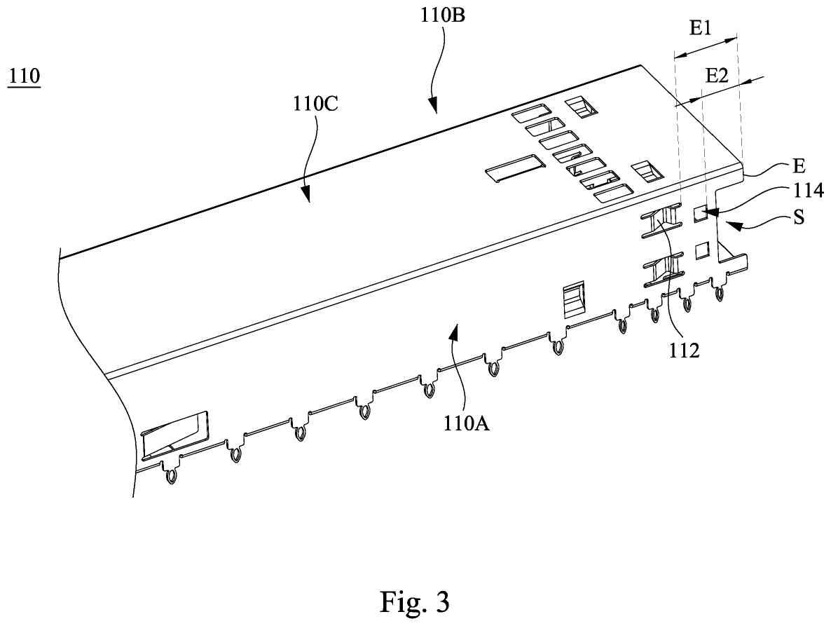

Referring to FIG. 3, the surface of the cage 100 adjacent to the printed circuit board B is a bottom wall 100D, in this embodiment, the left side and the right side of the cage 100 are substantially mirrored/symmetrical. Unlike traditional cages that require an opening for an SMT connector to pass through and connect with the PCB, in the present embodiment, the entire bottom wall 100D of the cage has no port opening preserved for SMT connector. The signal received by the plug 200 is transmitted directly to other components via a cable extending backward from the plug 200 and the cage 100.

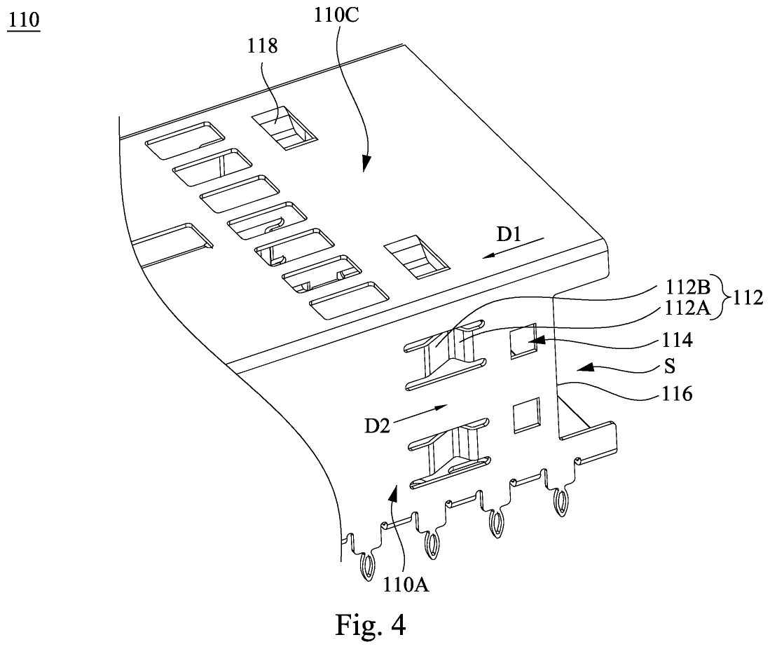

Referring to FIG. 4, in this embodiment, the first lateral wall 100A sequentially has two side-by-side elastic bridges 112, two alignment holes 114, and a wider substantially rectangle shaped notch 116 from its front end to rear end along a direction D2 opposite the insertion direction D1. Or say, the width of the first notch is larger than the maximum distance of the two alignment holes 114, the notch 116, two alignment holes 114, and two elastic bridges 112 are arranged in a mirrored configuration across a longitudinal axis.

The number of the elastic bridges 112 needs to be at least one, but may be freely increased to 2 to 5 as required and arranged in a vertical alignment.

The number of the alignment holes 114 is usually an even number, and the alignment holes 114 need to be vertically aligned with each other. In this embodiment, the alignment holes 114 need to be enclosed through holes. In terms of application, the plug 200 may enter the cage 100 in an insertion direction D1.

The notch 116 is formed by recessing from the end surface of the cage 100 in the insertion direction D1, and is a notch of an opening (non-enclosed) to allow the latch of the plug 200 to be embedded in. The width of the notch 116 is greater than the maximum distance between the two alignment holes 114.

In this embodiment, the elastic bridge 112 and the alignment hole 114 may be located in the same surface of the cage 100 (the first lateral wall 100A or the second lateral wall 100B), but when necessary, each of the elastic bridges 112 and each of the alignment holes 114 may be disposed in different surfaces. For example, by corresponding the adjustment of the design of the plug 200, the elastic bridge 112 and the alignment hole 114 can be modified to dispose on the top wall 100C and the bottom wall 100D of the cage 100, without affecting their functions.

FIG. 3 is a perspective view of the cage 100 of the cage 100 of FIG. 1. FIG. 4 is a partially enlarged view of the cage 100 of FIG. 3. As shown in FIG. 3 and FIG. 4, the elastic bridge 112 of the cage 100 is recessed toward the accommodating space S. In other words, the elastic bridge 112 is recessed from the first lateral wall 100A of the cage 100 and protrudes inward. A distance E1 between the elastic bridge 112 and an end edge E of the cage 100 is greater than a distance E2 between the alignment hole 114 and the end edge E of the cage 100.

In this embodiment, the elastic bridge 112 includes a first inclined portion 112A and a second inclined portion 112B adjoining the first inclined portion 112A, and the first and second inclined portion 112A and 112B have elasticity due to their material properties (e.g., metal). The first inclined portion 112A is located between the second inclined portion 112B and the alignment hole 114, and the slope of the first inclined portion 112A is greater than the slope of the second inclined portion 112B. In other words, the slope of the first inclined portion 112A closer to the alignment hole 114 is larger. Such a design facilitates blocking the plug 200 (see FIG. 1) with the insertion direction D1 to enter, and facilitates generating elastic force to push the plug 200 in the opposite direction D2.

Referring to FIG. 4, in this embodiment, the top wall 100C of the cage 100 is deformed inward to form a stop 118 that is configured to abut against the plug 200 by its sidewall in a thickness direction, and to limit the maximum insertion depth for the plug 200. Or say, the stop 118 having a stopping wall facing the rear opening of the cage, a direction of a normal vector of the whole stopping wall being substantially parallel to the longitudinal direction.

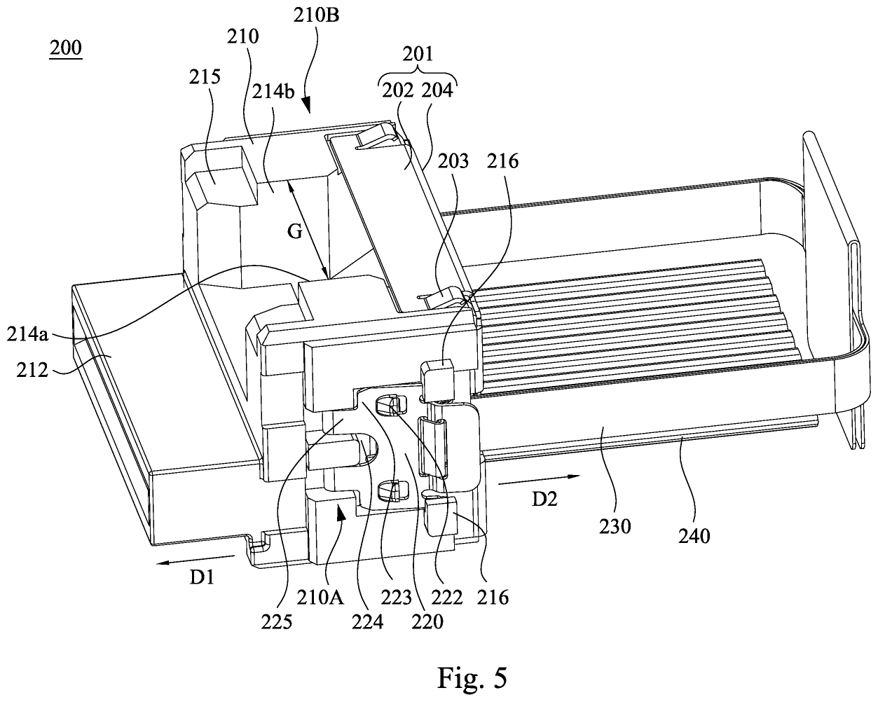

In the following description, the plug in this embodiment will be explained. FIG. 5 is a perspective view of the plug 200 of FIG. 1. As shown in FIG. 5, the plug 200 includes a base 210 and a latch (Latch) 220, a wire end printed circuit board (not shown), and a cable 240. The base 210 has a port 212 facing the insertion direction D1, and the port exposing at least a portion of a terminal set secured therein. The cable 240 is connected with the terminal set within the base 210 and extends away from the base 210.

In this embodiment, the base 210 is a molded part formed by an injection molding process, and is integrally formed as a single piece (One piece formed). The base 210 has a left pillar 214a, a right pillar 214b and a base portion connected therebetween. The left pillar 214a and the right pillar 214b have a top surface with same height. The port 212 is a part of the base portion. The plug 200 further includes a metal plate 201, a vertical portion 202 of the metal plate 201 covers at least a portion of a vertical gap G between the left pillar 214a and the right pillar 214b, and a horizontal portion 204 of the metal plate 201 covers at least a portion of a horizontal gap between the left pillar 214a and the right pillar 214b. The vertical portion 202 of the metal plate 201 has a plurality of deformable guiding arms 203 extending beyond the top surfaces of the left pillar 214a and the right pillar 214b. The horizontal portion 204 of the metal plate 201 has a plurality of parallel arranged heat dissipation holes 205 (see FIG. 1) for allowing air to pass therethrough. Each of the left pillar 214a and the right pillar 214b of the base 210 has a step structure 215 facing toward the insertion direction D1. The step structure 215 is disposed on the end surface of the front end of the base 210 and recessed in the opposite direction D2. The step structure 215 has a vertical lateral surface disposed on the bottom portion of the step structure for abutting against an external element. For example, during pushing the base 210 into the cage 100, when the vertical end surface of the step structure 215 abuts against the stop 118 (see FIG. 4) of the cage 100, the plug 200 cannot advance further, thereby limiting the maximum insertion depth for the plug 200. When the plug 200 is at the maximum insertion depth, the base 210 and the latch 220 are at least partially exposed through the notch 116 and protrude from the notch 116. The term “exposed” is referred to as “not completely covered”.

In this embodiment, two latches 220 are respectively fixed on a first side surface 210A and a second side surface 210B of the base 210, and the latch 220 is formed by stamping, cutting, and deforming a single metal plate. Each of the latches 220 has a flexible plate 223, a fixed plate 224 and two C-shaped connecting portions 225 connecting the flexible plate 223 and the fixed plate 224, and each of two latches 220 is connected with the base 210 via the fixed plate 224. The left pillar 214a and the right pillar 214b have two abutting protrusions 216 formed on an external surface thereof respectively, and each pair of the abutting protrusions 216 forms a gap therebetween for allowing a portion of the flexible plate 223 to pass therethrough. The latch 220 has two side-by-side ramps 222 thereon. In this embodiment, a side of the ramp 222 in the insertion direction D1 has a guiding surface, and another side is a substantially vertical surface, thereby forming a barb structure to be embedded in the alignment holes 114 (see FIG. 4) to prevent the plug 200 from separating from the cage 100.

In this embodiment, the plug 200 further includes a strap 230. The strap 230 is made of soft material (e.g., plastic), has a ring shape, and is integrally formed as a single piece. The strap 230 connects both of the flexible plates 223 of the latches 220. Two ends of the strap 230 are respectively wrapped around the two latches 220. Moreover, when the strap 230 is pulled in the opposite direction D2, the strap 230 drives the two latches 220 to elastically deform to change the position of the corresponding ramp 222, and the two latches 220 deform under force to exit the alignment hole 114 (see FIG. 4), thereby separating from the cage 100.

It is to be noted that the connection relationships, the materials, and the advantages of the elements described above will not be repeated in the following description. In the following description, the state of the aforementioned plug 200 positioned in the cage 100 of the cage 100 will be explained.

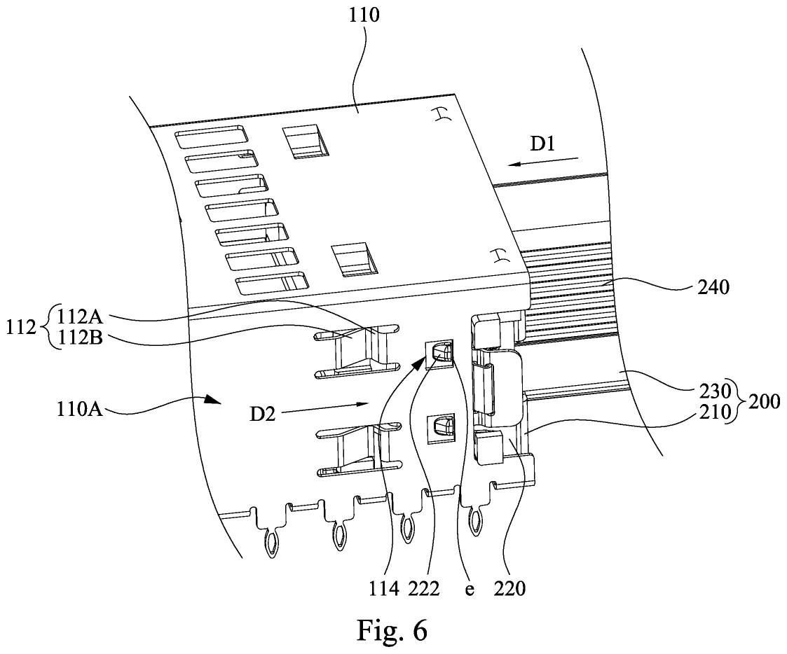

FIG. 6 is a partially enlarged view of the plug 200 of FIG. 5 when being coupled with the cage 100 of FIG. 4. As shown in FIG. 6, when the plug 200 is inserted into the accommodating space S (see FIG. 4) surrounded by the cage 100 of FIG. 4 in the insertion direction D1 under force, the base 210 can enter the accommodating space S until it directly contacts or compresses the first inclined portion 112A of the elastic bridge 112. At this moment, although the ramp 222 of the base 210 is located in the alignment hole 114 of the cage 100, the ramp 222 may separate from an edge e of the alignment hole 114. When the external force applied to the plug 200 is removed, the elastic bridge 112 can push the plug 200 in the direction D2 opposite the insertion direction D1, such that the ramp 222 of the plug 200 is not only coupled with the alignment hole 114, but also ensures that the ramp 222 abuts against the edge e of the alignment hole 114 without gap or with a decreased gap to improve positioning effect. In other words, when the elastic bridge 112 is abutted against an external component, the elastic bridge 112 is elastically deformed and applies a reverse force to the external component, thereby changing the position of the portion of the external component in the alignment hole 114 (e.g., the ramp 222). That is, when the plug 200 is plugged into the cage 100 via the rear opening, the ramps 222 enter the alignment holes 114 respectively and the elastic bridge 112 pushes the plug 200 backward for ensuring the ramps 222 to be contacted with the cage 100. Through the aforementioned design, the cage 100 (see FIG. 1) and the plug 200 can prevent from forming large displacement due to vibration or external force factors, and thus the stability of the electrical connection between the plug 200 and the cage 100 can be improved, which facilitates signal transmission quality.

In summary, since the board end connector has the elastic bridge and the alignment hole, and the base of the plug has the ramp, the ramp of the base can be coupled with the alignment hole of the board end connector when the plug enters the accommodating space surrounded by the board end connector in an insertion direction, and the elastic bridge can push the plug in a direction opposite the insertion direction by the elastic force of the elastic bridge, such that the ramp abuts against the edge of the alignment hole without gap. The aforementioned board end connector and plug can prevent from forming displacement due to vibration or external force factors, and thus the stability of the electrical connection between the plug and the board end connector can be improved, which facilitates signal transmission quality.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A board end connector, comprising:
a cage, having a top wall, a bottom wall, a first lateral wall and a second lateral wall, the first lateral wall and the second lateral wall connecting the top wall and the bottom wall respectively for forming an accommodating space therein, the cage having a front opening and a rear opening, the first lateral wall having at least one elastic bridge and at least one alignment hole at a rear side of the cage, the elastic bridge being recessed toward the accommodating space, when the elastic bridge is abutted and elastically deformed, a reverse force shall be provided thereby.

2. The board end connector of claim 1, wherein the elastic bridge and the alignment hole of the cage are located on a same surface.

3. The board end connector of claim 1, wherein the first lateral wall sequentially having a first notch, two alignment holes, and two elastic bridges along a longitudinal direction, the first notch is substantially rectangle shaped, a width of the first notch is larger than the maximum distance of the two alignment holes, the first notch, the two alignment holes, and the two elastic bridges are arranged in a mirrored configuration across a longitudinal axis.

4. The board end connector of claim 3, wherein the second lateral wall sequentially having a second notch, two alignment holes, and two elastic bridges along the longitudinal direction, the second notch is substantially rectangle shaped, the second notch, the two alignment holes, and the two elastic bridges of the second lateral wall are arranged in a mirrored configuration across a longitudinal axis.

5. The board end connector of claim 3, wherein a distance between the elastic bridge and an end edge of the board end connector is greater than a distance between the alignment hole and the end edge of the board end connector.

6. The board end connector of claim 5, wherein the elastic bridge comprises a first inclined portion and a second inclined portion adjoining the first inclined portion, and the first inclined portion is located between the second inclined portion and the alignment hole, wherein a slope of the first inclined portion is greater than a slope of the second inclined portion.

7. The board end connector of claim 6, wherein the top wall is deformed inward to form a stop, the stop having a stopping wall facing the rear opening of the cage, a direction of a normal vector of the whole stopping wall being substantially parallel to the longitudinal direction.

8. The board end connector of claim 6, wherein whole of the bottom wall of the cage has no port opening formed thereon.

9. A plug, comprising:
a base, having a port facing an insertion direction, the port exposing at least a portion of a terminal set secured therein; and
a cable, connected with the terminal set within the base and extending away from the base,
two latches, secured on a first side surface and a second side surface of the base respectively, each of the latches having a flexible plate, a fixed plate and two C-shaped connecting portions connecting the flexible plate and the fixed plate, each of two latches connected with the base via the fixed plate, the flexible plate having at least two ramps.

10. The plug of claim 9, further comprising:
a strap connecting both of the flexible plates of the latches;
wherein when the strap is pulled, the strap drives the two latches to elastically deform to change a position of the corresponding ramp.

11. The plug of claim 9, wherein the base being one piece formed and has a left pillar, a right pillar and a base portion connected therebetween, the left pillar and the right pillar having a top surface with same height, the port is a part of the base portion, the plug further comprises a metal plate, a vertical portion of the metal plate covers at least a portion of vertical gap between the left pillar and the right pillar, a horizontal portion of the metal plate covers at least a portion of horizontal gap between the left pillar and the right pillar.

12. The plug of claim 11, wherein the vertical portion of the metal plate has a plurality of deformable guiding arms extending beyond the top surfaces of the left pillar and the right pillar.

13. The plug of claim 12, wherein the horizontal portion of the metal plate has a plurality of parallel arranged heat dissipation holes for allowing air to pass therethrough.

14. The plug of claim 11, wherein the left pillar and the right pillar have a step structure facing toward the insertion direction.

15. The plug of claim 11, wherein the left pillar and the right pillar have two abutting protrusions formed on an external surface thereof respectively, and each pair of the abutting protrusions forms a gap therebetween for allowing a portion of the flexible plate to pass therethrough.

16. A board end connector, comprising:
a cage, having a top wall, a bottom wall, a first lateral wall and a second lateral wall, the first lateral wall and the second lateral wall connecting the top wall and the bottom wall respectively for forming an accommodating space therein, the cage having a front opening and a rear opening, the first lateral wall having at least one elastic bridge and at least one alignment hole at a rear side of the cage, the elastic bridge being recessed toward the accommodating space; and
a plug, having:
a base, having a port facing an insertion direction, the port exposing at least a portion of a terminal set secured therein;
a cable, connected with the terminal set within the base and extending away from the base; and
two latches, secured on a first side surface and a second side surface of the base respectively, each of the latches having a flexible plate, a fixed plate and two C-shaped connecting portions connecting the flexible plate and the fixed plate, each of the two latches connected with the base via the fixed plate, the flexible plate having at least two ramps,
wherein, when the plug is plugged into the cage via the rear opening, the ramps enter the alignment holes respectively and the elastic bridge pushes the plug backward for ensuring at least one of the ramps to be contacted with the cage.
